(19) United States
(12) Patent Application Publication
(10) Pub. No.: US 2008/0255906 A1
(43) Pub. Date: Oct. 16, 2008

(54) Animal Management System

(75) Inventors: Duane H. Theuninck, Wichita, KS (US); Todd Allen, Newton, KS (US); Lawrence Langford, Wichita, KS (US)

Correspondence Address: Cargill Incorporated, 15407 McGinty Road West, MS 24, Wayzata, MN, 55391-2399, US

(73) Assignee: CARGILL, INCORPORATED, Minneapolis, MN (US)

(21) Appl. No.: 11/720,419

(22) PCT Filed: Nov. 29, 2005
(86) PCT No.: PCT/US05/43069

§ 371 Date: May 27, 2008

Related U.S. Application Data
(60) Provisional application No. 60/631,469, filed on Nov. 29, 2004.

(51) Int. Cl. G06Q 10/00

(52) U.S. Cl. 705/8; 705/1

(57) ABSTRACT

A method of managing animals includes receiving animals to be kept at an animal management location for an undetermined time before being removed at a shipping date. The animals area organized in several arrival groups. A future weight estimate and a future backfat estimate are generated for each of the animals. Each of the estimates is generated using at least one physical measurement of the animal and an equation for making estimations for a single animal. Based on the future weight estimate and the future backfat estimate, each of the animals is sorted into one of several predetermined sort groups for separate management at the animal management location. The predetermined sort groups are different from the arrival groups and are associated with different predefined shipping dates. A system for managing animals includes a measurement component and an estimation component that generates the future weight estimate and the future backfat estimate.

### CROSS-REFERENCE TO RELATED APPLICATION

This application claims priority to U.S. Provisional Application 60/631,469, filed Nov. 29, 2004 and entitled “ANIMAL MANAGEMENT SYSTEM,” the contents of which are incorporated herein by reference.

### FIELD OF THE INVENTION

The present invention generally relates to an animal management system. The present invention more particularly relates to endpoint management system for feedlot cattle.

### BACKGROUND OF THE INVENTION

It is known for a cattle processor to pay cattle producers more money for cattle that are expected to provide desirable carcasses. One criterion of a desirable carcass is carcass weight. Another criterion for desirable carcasses is “red meat yield,” or the proportion of saleable beef resulting from a carcass. Red meat yield is negatively correlated to carcass fatness and highly related to a USDA measure known as “yield grade.” Yield grade is measured on a scale from 1 to 5, with 5 being most fat. As cattle get fatter, yield grade value goes up and red meat yield goes down. In most market conditions, yield grade 4 and 5 carcasses are subjected to substantial discounts. Another criterion for desirable carcasses is degree of intramuscular fat, commonly referred to as “marbling.” Marbling is highly related to USDA quality grade. The typical target for marbling is a level associated with USDA Choice. Higher levels of marbling can bring price premiums while lower levels often cause significant price discounts. In general, marbling increases with overall carcass fatness.

Cattle typically arrive at feedlots in heterogeneous groups. It is common for weight of cattle within a pen to vary by 200 lbs or more. During the course of the feeding period, this weight spread tends to increase due to variation in growth rate of individual animals within the pen. There is similar variation in fatness of cattle and carcasses derived from those cattle. It is known and most common within the cattle feeding industry to harvest an entire pen of cattle at the same time. However, this known method of harvesting results in wide variation in resulting carcass weights (and red meat yield, yield grade and marbling) of cattle from the pen.

It is also known to provide a system to calculate an optimum or target condition for an individual cattle and select the individual cattle for shipment based on such calculation. Such known systems typically includes the use of ultrasound to determine a characteristic of the cattle (or carcass).

Existing systems typically uses the “Cornell Method” for allocating feed to individuals animals. The Cornell Method is shown by Fox et al., 1992 Journal of Animal Science 70:3578 and “Application of Ultrasound for Feeding and Finishing Animals: A Review” by P. L. Houghton and L. M. Turlington (Kansas State University, Manhattan 66506). However, such known system has several disadvantages including that an optimum or target condition is calculated for an individual cattle and a sorting decision is made for such individual cattle based on such calculation.

### SUMMARY OF THE INVENTION

The invention relates to managing animals.

In a first general aspect, a method of managing animals includes receiving animals that are to be kept at an animal management location for a yet undetermined time period before being removed therefrom at a shipping date. The animals are organized in several arrival groups. The method includes generating a future weight estimate and a future backfat estimate for each of the animals. Each of the respective estimates is generated using at least one physical measurement of the animal and an equation configured to make estimations for a single animal. The method includes sorting, based on the future weight estimate and the future backfat estimate, each of the animals into one of several predetermined sort groups for separate management at the animal management location. The predetermined sort groups are different from the arrival groups and are associated with different predefined shipping dates.

Implementations may include any or all of the following features. The predetermined sort groups may be managed separately at the animal management location. The separate management may include providing a different treatment for at least some of the predetermined sort groups. The different treatment may include a difference in implants that are administered. The separate management may include administering feed according to a feed allocation that is determined using a predefined algorithm. The predefined algorithm may take into account an estimated empty body fat measure. The estimated empty body fat measure for each animal may be generated using an ultrasound measurement. The physical measurement used in generating the future backfat estimate may include at least one measure selected from the group consisting of: (a) a backfat thickness measure; (b) a ribeye depth measure; (c) a marbling score measure; and (d) combinations thereof. The method may further include using the measure in estimating an empty body fat measure. The method may further include using the estimated empty body fat measure in estimating a future marbling measure. A standard shipping date may be established based on an average animal weight and an animal type, and the future backfat estimate may include one selected from the group consisting of: (a) an estimated backfat measure at a predefined time from a current date; (b) an estimated backfat measure at the standard shipping date; (c) an estimated backfat measure at a predefined time after the standard shipping date; and (d) combinations thereof. The future weight estimate may include a weight at a standard shipping date established based on an average animal weight and an animal type. The future weight estimate may be based at least in part on an estimated daily-gain-to-finish measure for each animal, and the estimated daily-gain-to-finish measure may also be directly used in the sorting. The sorting may also be based on an estimated days-to-critical-weight measure for each animal, the days-to-critical-weight measure being estimated using at least an estimated daily-gain-to-finish measure for each animal and a predefined critical weight for animals.

In a second general aspect, a system for managing animals includes a measurement component that performs physical measurements on animals that arrive in groups. The animals are kept at an animal management location for a yet undetermined time period before being removed therefrom at a shipping date. The system further includes an estimation component that generates a future weight estimate and a future backfat estimate for each of the animals. Each of the respective estimates is generated using at least one of the physical measurements of the animal and an equation configured to make estimations for a single animal. The system further includes several predetermined sort groups for separate management at the animal management location. The predetermined sort groups are different from the arrival groups and are associated with different predefined shipping dates, wherein the system assigns each of the animals to one of the predetermined sort groups based on the future weight estimate and the future backfat estimate.

Implementations may include any or all of the following features. The system may provide a feed allocation for administering feed, the feed allocation being determined using a predefined algorithm that takes into account an estimated empty body fat measure generated using an ultrasound measurement. The system may manage the animals in the several pens separately, including providing a different treatment for at least some of the predetermined sort groups. The different treatment may include a difference in implants that are administered. The different treatment may include a difference in feed allocation.

Embodiments of the invention may provide any or all of the following advantages. An animal management system may provide for making a sorting decision directed to a group of animals. An animal management system may provide a relatively significant number of animals that are not subject to significant price discounts by the market (e.g. by controlling live weight and thereby carcass weight, minimize excess fatness, optimize potential for marbling while controlling overall carcass fatness, etc.). An animal management system may feed groups to a more consistent endpoint in terms of carcass weight production and proportions of fat and protein in the carcass. An animal management system may manage animal harvest endpoint for purposes of controlling value of carcasses produced. An animal management system may sort pens of feedlot animals into slaughter groups in order to improve uniformity of carcass weight, manage carcass fatness and reduce price discounts for undesirable carcasses. An animal management system may provide for relatively good feed efficiency and low cost of production.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 schematically shows an example of an animal management system;

FIG. 2 shows an example of making an ultrasound measurement using the animal management system of FIG. 1;

FIG. 3 schematically shows an example of estimations and predictions that can be made using the animal management system of FIG. 1; and

FIG. 4 schematically shows another example of estimations and predictions that can be made using the animal management system of FIG. 1.

Like reference numerals in the various drawings indicate like elements.

### DETAILED DESCRIPTION

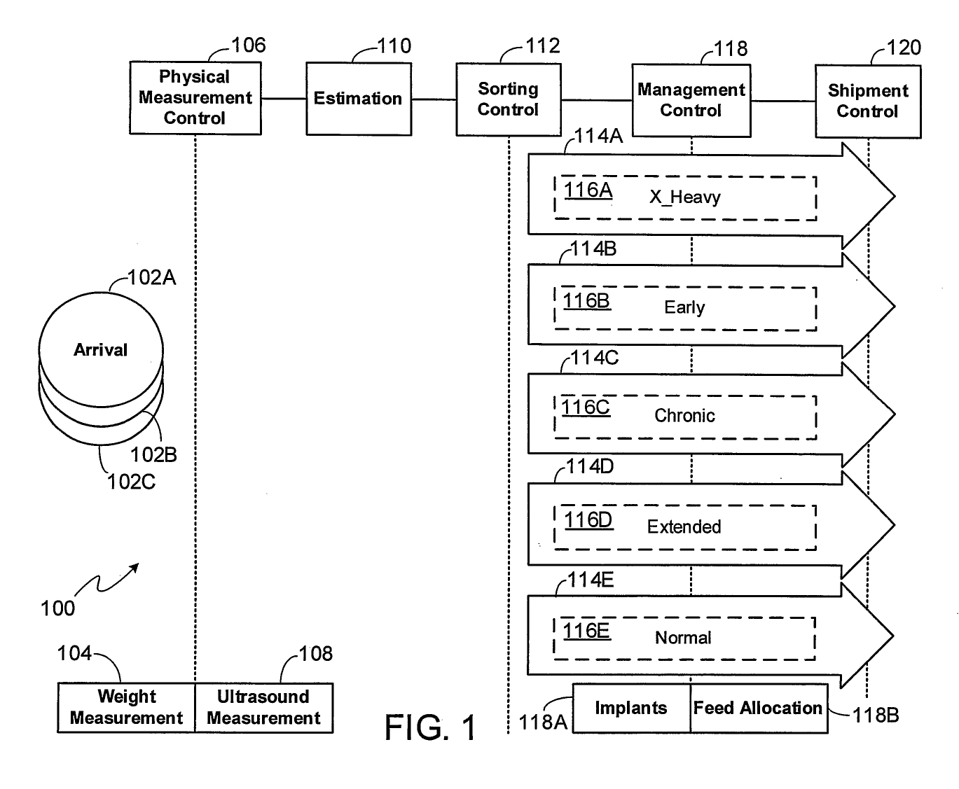

FIG. 1 shows a system 100 for managing animals at a feedlot. The system 100 uses weight and ultrasound information to make sorting decisions, commingles cattle at the time of sorting and allocates feed provided to a pen to individual animals within the pen. In general, the system 100 uses a combination of weight and ultrasound measurements of the live animal to predict future weight and body composition so that both factors can be accounted for in sorting and harvest date decisions according to a preferred embodiment.

Animals are brought to a feedlot with the expectation that they will later be shipped from the feedlot to a beef packing plant for slaughter. The exact length of time that each animal will spend at the feedlot has typically not been determined when the animal arrives. Rather, the specific shipping date will be determined while they are at the feedlot as will be described below.

Animals arrive at the feedlot in one or more arrival groups 102. The groups 102 may arrive at the same time or be distributed over time based on production needs and other factors. Upon arrival, each animal is individually identified using an ear tag or some other form of identification. Each animal is also weighed upon arrival. The weight measurement may be carried out using a weight measurement component 104, including a scale, that is controlled by a physical measurement control 106 that is part of the system 100. The identification and weighing may be carried out while the animals are processed through a chute or other device that temporarily restricts the animal's movement. An individual animal record is established in the system at this time.

After the initial processing, the cattle are fed in groups or lots (e.g. in pens) over some period of time. Feed is provided and feed records are maintained on a pen basis. A dominant breed code is assigned to each pen.

After some time of feeding, such as 30 days or more, the animals are subjected to additional processing. The animals are “reimplanted” with selected medicaments or compositions. Physical measurements are also taken of each animal. First, the animal is again weighed. Second, an internal characteristic of the animal is determined using ultrasound. The ultrasound measurement may be carried out using an ultrasound measurement component 108 that is controlled by the physical measurement control 106.

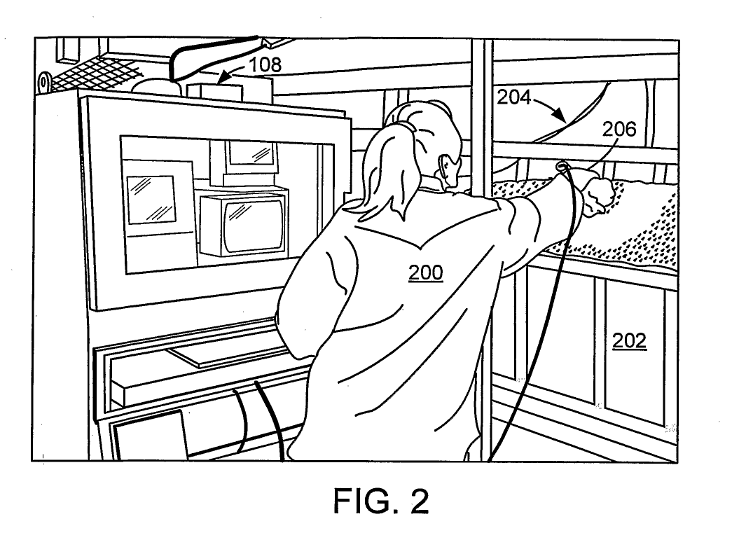

FIG. 2 shows an example of making an ultrasound measurement using the ultrasound measurement component 108. An operator 200 is measuring an animal 202 that is located in a processing chute 204. The operator applies a handheld ultrasound transducer 206 to a particular location on the animal 202 to make one or more measurements. The transducer 206 is connected to the ultrasound measurement component 108 which registers the measurement(s) for use in the system 100.

Several different characteristics can be measure using ultrasound. Examples of measurements include a measurement of backfat thickness, a measurement of ribeye depth and a marbling score measurement. Using the individual animal identification, this information is stored in the system 100 in association with the original weight of the individual animal.

The system 100 includes an estimation component 110 that makes calculations based on the individual animal measurements. The calculations may involve using equations configured to make estimations or predictions. Particularly, the estimation component 110 may generate a future weight estimate and a future backfat estimate for each of the animals using at least one of the physical measurements of the animal. The estimation component 110 may do so by inserting the physical measurement(s) into an equation that is configured to make estimations for a single animal. That is, the estimations and predictions are made on a individual animal basis while management of animals in the system 100 is done on a group basis. The animal will be sorted into one of several sort groups based on the calculations, as will be described. The estimation component 110 may perform the calculations while the animal is captured in the processing chute 204 or thereafter.

Data that the estimation component 110 may use in the calculations includes: Initial weight, Date of initial weight, Current weight, Date of current weight, expected average days to market for the group, Ultrasound backfat, Ultrasound ribeye depth, Ultrasound marbling and Pen breed code. Data that the estimation component 110 may generate based on the calculations includes: Days fed, Average daily gain to date, Estimated future feed intake, Estimated future average daily gain, Estimated weight at future dates and Estimated backfat at future dates. One aspect of the calculations is that current weight and ultrasound measures are used to estimate current Empty Body Fat (EBF) of the live animal. The estimate of EBF is employed in calculation of future gain and weight. Alternatively, marbling of the animal may also be estimated.

Some or all of the estimations and predictions generated by the estimation component 110 may be used by a sorting control component 112 in the system 100. The operations performed by the sorting control component 112 include passing the estimations and predictions through a series of logical tests to make sorting decisions. The sorting control component 112 provides a signal representative of the sorting decision. For example, the sorting decision may comprise assigning each animal to one of several predetermined sort groups 114.

In this example, the system 100 includes five sort groups 114A-E. Each of the sort groups 114 may be associated with at least one separate pen 116 in which animals belonging to the sort group are to be kept. The system 100 sorts the animals into different sort groups to facilitate the group-based management of animals.

Each of the sort groups 114 is associated with a different predefined shipping date. For example:
The sort group 114A is named “X_Heavy” for animals that are collectively referred to as being extra heavy and that will be shipped very soon after sorting. This group includes cattle that are extremely heavy or extremely fat at the time of sorting (e.g. a too high weight, too much backfat, etc.).
The sort group 114B is named “Early” for animals that are to be given a shipping date that is early relative to a standard shipping date based on average values, for example 20-40 days early.
The sort group 114C is named “Chronic” for animals that are not developing normally and that will be shipped very soon after sorting. This group includes cattle that are gaining unusually slowly (e.g. have a too low average daily gain).
The sort group 114D is named “Extended” for animals that are to be given a shipping date that is extended relative to the standard shipping date, for example extended by 30-50 days.
The sort group 114E is named “Normal” for animals that do not meet the qualifications for any of the other sort groups and that will be shipped at the standard shipping date.

Thus, the predefined shipping dates may be precise, such as the standard shipping date for the “Normal” animals, or flexible, such as the 20-40 days interval for the “Early” animals. Nevertheless, each of the sorting groups are associated with different shipping dates.

After the sorting decision is made, the system 100 assigns a hormone “implant” regimen based on pre-determined logic relating to the particular sort group and the implant. The implant is administered through a management control component 118 in the system 100. For example, the management control component 118 has an implants module 118A by which the correct type and amount of implant is identified for each sort group. The implants module 118A may be located at the processing chute 204 so that the implants can be made shortly after the sorting decision has been made.

The sorting control component 112 performs the sorting substantially immediately when an animal leaves the processing chute 204. With five sort groups, individual animals that go into the sorting process from one pen may go out of the process into one of the five pens 116. In practice, individuals identified as X-Heavy or Chronic may go into the same pen because both groups will be shipped soon after sorting. In each of the sort groups 114, the animals will be combined with cattle from other pens that have also gone through the sorting. The net effect is that individual animals are intentionally co-mingled rather than staying with same group of animals in a pen for the entire feeding process.

In an alternative embodiment, each of the sort groups 114 is not associated with one of the pens 116. Rather, the animals that have been sorted into one of the sort groups may be identified by ear tag and all animals go back to their original pen or another common pen for continued feeding. At a point near slaughter, the animals are then sorted according to their respective sort groups using the ear tags.

The management control component 118 includes a feed allocation module 118B that manages the feed allocation for each of the sort groups. With the commingling that occurs, conventional methods to allocate feed provided to a pen to individual animals within that pen may be used. One such method includes the “Cornell” method. Feed allocation to individuals may occur every time cattle are weighed. Calculated feed intake of an individual may be carried with that individual as it moves to a new pen group. Particularly, ultrasound measurements may be used to predict an empty body fat (EBF) measure of live cattle, which improves the accuracy of Cornell method calculations.

The following are a number of additional exemplary details about the system 100. A standard average harvest date (SHD) may be established when a pen of cattle arrives at the feedlot. The SHD is based on historical averages for the average weight and type of cattle and may use feedlot-specific formulas. The second individual weighing, which precedes the sorting decision, may be done 60-120 days prior to the SHD. Internal measurements and current weight may be used to estimate the EBF measure, for example using proprietary modified inputs into equations published by Guiroy et al (2001, Journal of Animal Science 79:1983) for estimation of EBF from carcass measurements. Individual cattle may be normalized to a standard growth curve based on EBF (e.g. with standard, published methods).

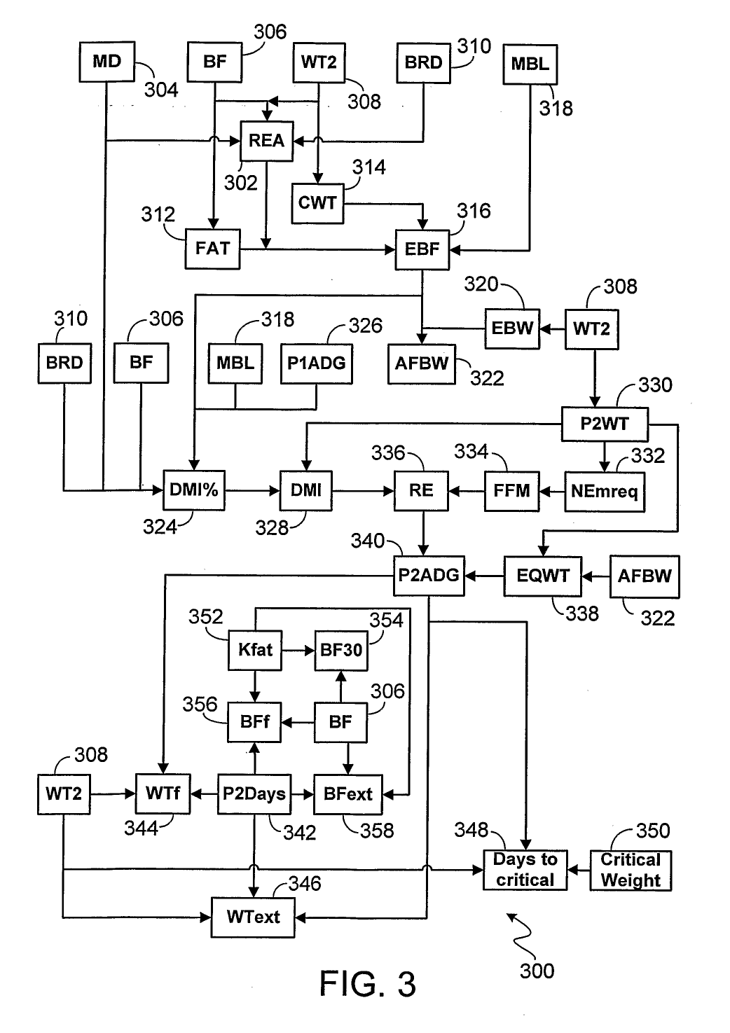

FIG. 3 schematically shows an example of estimations and predictions that the estimation component 110 can perform. Particularly, FIG. 3 shows an exemplary process 300 that can be implemented as software or other computer-executable instructions in the system 100. Particularly, the process may be implemented as modules (to be described below) in the estimation component 110. The process 300 may begin with estimating the EBF measure. To do so, the process first determines a ribeye area (REA) according to the following equation:

REA(cm²)={7.594+(0.06885*MD)−(0.199*BF)+(0.00387*WT2)−(0.244*BRD)}*6.45 (1)

Wherein
MD=Ultrasound muscle depth
BF=Ultrasound backfat
WT2=Reimplant weight
BRD=Dominant breed; English=3, Brahman=2, Exotic=1

Equation (1) may be implemented as REA module 302 that obtains values from the following modules: MD 304, BF 306, WT2 308 and BRD 310. The MD 304 and BF 306 may receive input from the ultrasound measurement component 108. The WT2 308 may receive input from the weight measurement component 104. The BRD 310 may receive input that an operator makes into the system 100.

The process 300 determines a fat measure (FAT) as:

FAT(cm)=BF/10 (2)

Equation (2) may be implemented as FAT 312 which obtains values from the BF 306. The process 300 determines a carcass weight (CWT) measure as:

CWT(kg)=WT2*0.59*0.4536 (3)

Equation (3) may be implemented as CWT 314 that obtains values from the WT2 308. The process 300 then determines the EBF as:

EBF=17.76027+(4.68142*FAT)+(0.01945*CWT)+(0.81855*MBL)−(0.06754*REA) (4)

Where MBL=Ultrasound marbling

Equation (4) may be implemented as EBF 316 which receives values from the FAT 312, the CWT 314, an MBL 318 and the REA 302. The MBL 318 may receive input from the ultrasound measurement component 108.

The process 300 then estimates an adjusted final body weight (AFBW) for the animal, which is the weight at 28% EBF. To do so, the process may begin by estimating an empty body weight (EBW) for the animal:

EBW=WT2*0.4536*0.891 (5)

Equation (5) can be implemented as EBW 320 which receives values from the WT2 308. The process 300 then determines the AFBW as:

AFBW(kg)=[EBW+{(28−EBF)*14.26}]/0.891 (6)

Equation (6) can be implemented as an AFBW 322 which receives values from the EBW 320 and from the EBF 316. The process 300 then predicts a dry matter intake percentage (DMI %) measure represented as a percentage of bodyweight, the DMI % being predicted thus:

$$DMI \% = 9.876 - ( .01914 * MD ) - ( .446 * EBF ) + ( .06201 * BRD ) + ( .234 * BF ) + ( .36 * MBL ) + .002581 * P 1 ADG * EBF ) \qquad ( 7 )$$

Equation (7) can be implemented as DMI % 324 which receives values from the MD 304, the EBF 316, the BRD 310, the BF 306, the MBL 318 and a P1ADG 326. The P1ADG 326 represents an average daily gain determined from the animal's weight increase between the initial weighing and the second weighing after feeding. The P1ADG may receive values from the weight measurement component 104 and from the animal record showing when the animal arrived at the feedlot. The process 300 determines a dry matter intake (DMI) measure as:

DMI(lb)=P2WT*DMI %*0.01 (8)

Wherein P2WT=(WT2+1380)/2 for steers
P2WT=(WT2+1250)/2 for heifers

Equation (8) can be implemented as DMI 328 which receives values from a P2WT 330 and the DMI % 324. The P2WT 330 may receive values from the WT2 308 and from the animal record showing whether the animal is a steer or heifer.

The process then predicts an average daily gain. Individual cattle may be normalized to a standard growth curve based on EBF, for example with standard published equations. The expected energy intake may be calculated from the predicted feed intake and energy density of the diet fed. The average daily gain may be estimated from the just mentioned published energy requirement equations. The amount of fat in the gain can be estimated as in equations of Tedeschii et. al., 2004 (Agricultural Systems 79:171-204). This allows for estimation of EBF at future points in time. In predicting the average daily gain, the process may first determine a requirement of net energy for maintenance (NEmreq) as:

NEmreq=0.077*{(P2WT*0.4536)0.75} (9)

Equation (9) can be implemented as an NEmreq 332 which receives values from the P2WT 330. The process 300 determines a feed required for maintenance (FFM) as:

FFM=NEmreq/NEm (10)

Wherein NEm=net energy maintenance content of feed, for example 1.046

Equation (10) can be implemented as an FFM 334 which receives values from the NEmreq 332. The process 300 then determines a retained energy (RE) as:

RE=(DMI−FFM)*NEg (11)

Wherein NEg=net energy gain content of feed, for example 0.7284

Equation (11) can be implemented as an RE 336 which receives values from the DMI 328 and from the FFM 334. The process 300 determines an equivalent weight (EQWT) as:

EQWT=(478/AFBW)*P2WT (12)

Equation (12) can be implemented as an EQWT 338 which receives values from the AFBW 322 and from the P2WT 330. The process 300 then determines a predicted daily gain (P2ADG) from the second weighing onward as:

P2ADG(lb)={13.91*(RE0.9116)*(EQWT−0.6837)}/0.4536 (13)

Equation (13) can be implemented as a P2ADG 340 which receives values from the RE 336 and from the EQWT 338. The process 300 then calculates a days to ship measure (P2 Days), representing the number of days from today until an estimated finish date and today. The P2 Days relies on standard formulas and average values, such as the SHD. This may be implemented as a P2Days 342.

Using P2ADG and an estimated finish date, the process 300 calculates expected weight at finish (WTf) as:

WTf=WT2+(P2Days*P2ADG) (14)

Equation (14) can be implemented as a WTf 344 which receives values from the WT2 308, the P2 Days 342 and the P2ADG 340. The process 300 then determines a standard average daily gain (ADG). The process also determines a Standard Finish Weight based on sex and initial weight. In determining the ADG, the process calculates a weight after extended feeding (WText) as:

WText=WT2+({P2Days+45}*P2ADG) (15)

Equation (15) can be implemented as a WText 346 which receives values from the WT2 308, the P2 Days 342 and the P2ADG 340. Knowing weight today and expected daily gain, the process calculates a number of days till critical weight is reached (Days to critical) as:

Days to critical=(Critical Wt−WT2)/P2ADG (16)

Equation (16) can be implemented as a Days to critical 348 which receives values from a Critical Weight 350, the WT2 308 and the P2ADG 340. A value for the Critical Weight 350 may be input by an operator of the system and is presently 1460 lbs.

Carcass fatness at future dates is estimated using an equation for growth of backfat. One such equation is described in U.S. Pat. No. 5,960,105 issued Sep. 28, 1999 to Brethour and titled “Measurement of intramuscular fat in cattle” and U.S. Pat. No. 5,398,290 issued Mar. 14, 1995 to Brethour and titled “System for measurement of intramuscular fat in cattle.” The equation may be adjusted using breed-specific coefficients.

Carcass marbling at future dates can be estimated. One method of estimation involves using an equation for growth of marbling of the type disclosed in the 5,960,105 and 5,398,290 patents. The equation may be adjusted using breed-specific coefficients. An alternative method is to estimate marbling from predicted EBF.

The system 100 may have defined therein a Backfat growth coefficient (Kfat) implemented as a Kfat 352 in the process 300. Values for the Kfat 352 may be input by an operator depending on the dominant breed of animals in the group that is currently being sorted and are presently as shown in Table 1.

TABLE 1

| Dominant Breed | Kfat |
|---|---|
| Brahman | .009 |
| English | .01 |
| Exotic | .008 |

Using the applicable Backfat growth coefficient, the process 300 calculates an estimated backfat in 30 days from today (BF30) using the exponential equation:

BF30=BF*Exp(30*Kfat) (17)

Equation (17) can be implemented as a BF30 354 which receives values from the BF 306 and from the Kfat 352. The process 300 calculates a backfat at shipment measure (BFf) using another exponential equation:

BFf=BF*Exp(P2 Days*Kfat) (18)

Equation (18) can be implemented as a BFf 356 which receives values from the BF 306, the P2 Days 342 and the Kfat 352. The process 300 calculates backfat after extended feeding (BFext) using another exponential equation:

BFext=BF*Exp({P2Days+45}*Kfat) (19)

Equation (19) can be implemented as a BFext 358 which receives values from the BF 306, the P2 Days 342 and the Kfat 352.

The process 300 as applied to an individual animal may end after performing the above calculations. The process may then be repeated for another animal using its particular values. One or more of the obtained estimations or predictions for each animal may be used in sorting the animal into any of the several sort groups. For example, the Days to critical, BF30, BFf, WTf BFext and P2ADG may be used as described in the following example.

The sorting control component 112 obtains values for each individual animal from the estimation component 110. The sorting control component 112 then passes some or all of the values through one or more predefined logical tests associated with the respective sort groups. When the values for the individual animal first match one of the logical tests, the sorting control component 112 decides to add the animal to the one of the sort groups 114 that is associated with the test. The sorting control component 112 may then direct the operator to open and close of pen gates such that the animal is physically brought into the one of the pens 116 that belongs to the selected sort group. In an implementation where animals from different sort groups are temporarily mixed together after the sorting decision, the sorting control component 112 can register the animal's identification (such as ear tag number) in the system 100 as belonging to that particular sort group.

The system 100 may have defined therein criteria against which the values for the individual animal will be compared in the logical tests. Such criteria may include:

(i) ADGmin, a flag to identify cattle with unusually slow growth rate.

(ii) CRITWThigh, a maximum acceptable live weight at harvest.

(iii) CRITWTlow, a minimum acceptable live weight at harvest.

(iv) CRITFAT, a maximum acceptable backfat thickness at harvest.

(v) WTstd, an expected weight at harvest based on historical population trends.

The following are examples of the logical tests that can be used. First, an animal is added to the X_Heavy sort group 114A if the following conditions are met:

(a) Days to critical is less than 31

OR

(b) BF30 is greater than a predefined limit for cut-out backfat.

The cut-out backfat limit may be set at any value and is currently 0.7 in (17.78 mm). The animal values are used in the test for the Chronic sort group 114C. Here, the Chronic sort group has two tests, each of which defines qualifications for being included in the sort group. First, the animal is added to the Chronic sort group 114C if the following conditions are met:

(c) initial weight is less than 750 lbs.

AND

(d) daily gain to this point is less than 1.25.

Second, the animal is added to the Chronic sort group 114C if the following conditions are met:

(e) initial weight is greater than 749

AND

(f) daily gain to this point is less than 1.50.

If the animal does not meet the test for the X_Heavy or Chronic sort group, its values are used in the test for the Early sort group 114B.

The animal is added to the Early sort group 114B under the following conditions:

(g) Days to critical is less than days to ship

OR

(h) BFf is greater than the predefined limit for cut-out backfat.

If the animal does not meet any of the tests for the Early sort group, its values are used in the test for the Extended sort group 114D. Here, the Extended sort group has three tests, each of which defines qualifications for being included. First, the animal is added to the Extended sort group 114D if the following conditions are met:

(i) initial weight is less than 750

AND

j) daily gain to this point is greater than 1.25

AND

(k) WTf is less than 870

AND

(l) BFext is less than the predefined limit for cut-out backfat.

Second, the animal is added to the Extended sort group 114D if the following conditions are met:

(m) initial weight is greater than 749

AND

(n) daily gain to this point is greater than 1.50

AND

(o) WTf is less than 870

AND

(p) BFext is less than the predefined limit for cut-out backfat.

Third, the animal is added to the Extended sort group 114D if the following conditions are met:

(q) daily gain to finish (P2ADG) is greater than 2.0

AND

(r) expected weight is greater than 870

AND

(s) BFext is less than the predefined limit for cut-out backfat

AND

(t) WText is less than the critical weight.

If the animal does not meet any of the tests for the Extended sort group, it is automatically added to the Normal sort group 114E. Thus, after this sorting the individual animal has been assigned to one of the sort groups. The system 100 can therefore manage that animal and the others of the same sort group, on a group basis, for the remainder of the feeding period until the shipping date. More or fewer predefined sort groups may be used, and they can each be associated with one or more logical tests.

The different shipping dates for the respective sort groups are managed by a shipment control component 120 in the system 100. For example, the shipment control component can initiate the processing that causes the animals in the pens 116A and C to be shipped shortly after sorting. Similarly, it can initiate the process of shipping the animals in the pen 116B a certain time before the SHD, the animals in the pen 116E at the SHD, and the animals in the pen 116D at a certain time after the SHD.

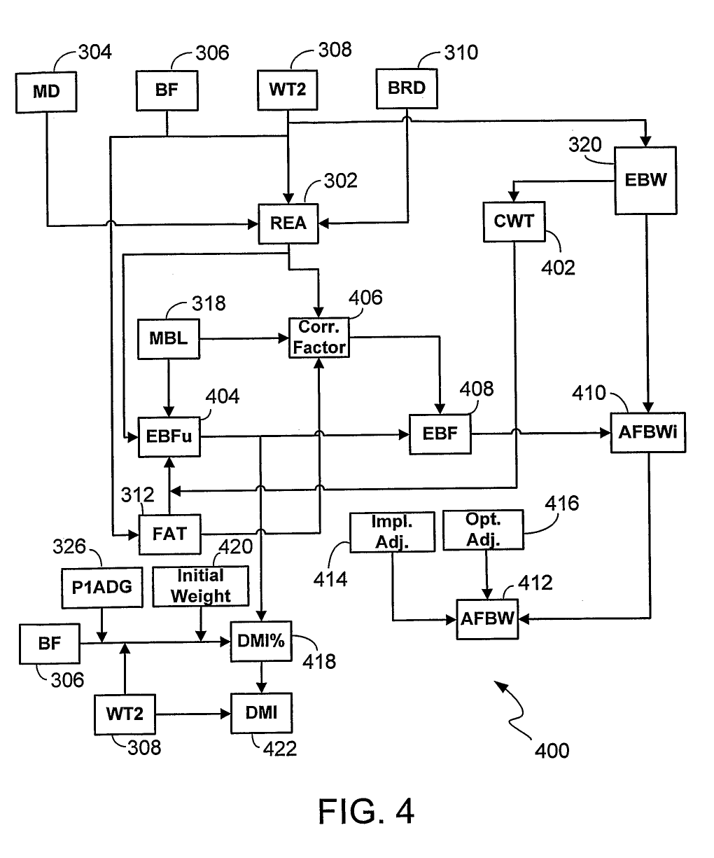

Another example of the evaluation and sorting process will now be described with reference to FIG. 4, where a process 400 is shown. Some aspects shown in the process 300 that may be implemented identically in the process 400 are not explicitly shown.

The process 400 estimates empty body fat from ultrasound measurements. In doing so, the process first determines REA using Equation (1) above. The estimation component 110 may include the REA module 302 that obtains values from the MD 304, the BF 306, the WT2 308 and the BRD 310. The process 400 determines FAT using Equation (2) above. The estimation component 110 may include the FAT module 312. Similarly, the process 400 determines the EBW using Equation (5) above, for example using the EBW 320.

The process 400 takes the EBW into account when determining the CWT. For example, the CWT may be determined as:

CWT(kg)=(EBW−32.29)/1.36 (20)

Thus, a CWT 402 that performs this calculation may be implemented. Next, the process 400 determines an ultrasound-based EBF, referred to as EBFu, as:

EBFu=17.76027+(4.68142*FAT)+(0.01945*CWT)+(0.81855*MBL)−(0.06754*REA) (21)

Equation (21) can be implemented using an EBFu 404 that receives values from the FAT 312, the CWT 402, the MBL 318 and the REA 302. The process 400 estimates corrected empty body fat, measured in percent. In doing so, the process 400 first determines a correction factor as:

Correction Factor=0.736−(0.01107*EBFu)−(0.0324*MBL)−(0.001848*REA)−(0.06554*FAT) (22)

Equation (22) can be implemented as a Correction Factor 406 which receives values from the EBFu 404, the MBL 318, the REA 302 and the FAT 312. Next, the process determines the EBF as:

EBF=EBFu−(EBFu*Correction Factor) (23)

Equation (23) can be implemented as EBF 408 which receives values from the EBFu 404 and from the Correction Factor 406. The process estimates adjusted final body weight (AFBW), which is the weight at 28% EBF. In so doing, the process 400 calculates an initial estimate of AFBW (AFBWi) as:

AFBWi(kg)=[EBW+{(28−EBF)*14.26}]/0.891 (24)

Equation (24) can be implemented as an AFBWi 410 which receives values from the EBW 320 and from the EBF 408. Next, the process 400 determines the AFBW as:

AFBW(kg)=AFBWi+Implant Adj.+Optaflexx Adj. (25)

Equation (25) can be implemented as an AFBW 412 which receives values from the AFBWi 410, an Implant Adjustment 414 and an Optaflexx Adjustment 416. Values for the Implant Adjustment 414 may be input by an operator depending on the implant dose. Presently, the Implant Adjustment 414 has the values shown in Table 2.

TABLE 2

| Implant dose | Adjustment |
|---|---|
| <20 | 0 |
| 20 to 89.99 | 10 |
| 90 to 139.99 | 20 |
| 140 to 180 | 35 |
| >180 | 40 |

Similarly, the values for the Optaflexx Adjustment 416 may be input by an operator depending on whether Optaflexx is fed. Presently, the Optaflexx Adjustment 416 has the values shown in Table 3.

TABLE 3

| Optaflexx | Optaflexx Adjustment |
|---|---|
| is fed | 150 |
| is not fed | 0 |

The process 400 also predicts dry matter intake (DMI). In so doing, the process 400 determines a DMI percentage measure (DMI %) as:

DMI %=2.691−(0.005719*WT2)+(0.004902*P1ADG*EBFU)+(0.001691*Initial wt)+(0.000001855*{WT2̂2})−(0.04951*BF)+(67.817*{EBFu/WT2}) (26)

Equation (26) can be implemented as a DMI % 418 which receives values from the WT2 308, the P1ADG 326, the EBFu 404, an Initial Weight 420 and the BF 306. Next, the process 400 determines the DMI as:

DMI(lb)=WT2*DMI %*0.01 (27)

Equation (27) can be implemented as a DMI 422 which receives values from the WT2 308 and from the DMI % 418.

The determined AFBW and DMI can be used in subsequent calculations substantially as described with reference to FIG. 3. For example, AFBW and DMI can be used in predicting the P2ADG. Backfat estimations may be done as described above.

The sorting decisions may be done essentially as described with reference to the logical tests above. In some implementations, there are differences in the logical tests or in the used criteria. For example, the logical tests for the X_Heavy sort group 114A and the Early sort group 114B may be the same as above, while the tests for the Chronic sort group 114 C and the Extended sort group 114 D may be somewhat different. Here, an animal is added to the Chronic sort group if the following condition is met:

(aa) daily gain to this point (P1ADG) is less than 1.25.

If the animal does not meet the logical test for the Chronic sort group 114C, its values are used in the test for the Extended sort group 114D. The animal is added to the Extended sort group if the following conditions are met:

(bb) P1ADG is greater than 1.25

AND

(cc) P2ADG is greater than 2.0

AND

(dd) BFext is less than the predetermined limit for cut-out backfat

AND
(ee.1) WText is less that critical weight
OR
(ee.2) WTf is less than MINWT.

Wherein MINWT=950 for steers and 900 for heifers.

Thus, each of the exemplary processes 300 and 400 can be used in the system 100, which is configured to manage animals using predetermined sort groups associated with different shipping dates. Also, animals are added to the respective sort groups based on weight estimations and backfat estimations obtained with single-animal equations using the measurements for each individual animal.

While embodiments have been described above, it should be understood that they are offered by way of example only. For example, ultrasound marbling limits could be included in the series of logical arguments used to make sorting decisions. The invention is not limited to a particular embodiment, but extends to various modifications, combinations, and permutations.

1. A method of managing animals, the method comprising:
receiving animals that are to be kept at an animal management location for a yet undetermined time period before being removed therefrom at a shipping date, the animals being organized in several arrival groups;
generating a future weight estimate and a future backfat estimate for each of the animals, each of the respective estimates being generated using at least one physical measurement of the animal and an equation configured to make estimations for a single animal; and
sorting, based on the future weight estimate and the future backfat estimate, each of the animals into one of several predetermined sort groups for separate management at the animal management location, wherein the predetermined sort groups are different from the arrival groups and are associated with different predefined shipping dates.

2. The method of claim 1, further comprising managing the predetermined sort groups separately at the animal management location.

3. The method of claim 2, wherein the separate management comprises providing a different treatment for at least some of the predetermined sort groups.

4. The method of claim 3, wherein the different treatment comprises a difference in implants that are administered.

5. The method of claim 2, wherein the separate management comprises administering feed according to a feed allocation that is determined using a predefined algorithm.

6. The method of claim 5, wherein the predefined algorithm takes into account an estimated empty body fat measure.

7. The method of claim 6, wherein the estimated empty body fat measure for each animal is generated using an ultrasound measurement.

8. The method of claim 1, wherein the physical measurement used in generating the future backfat estimate includes at least one measure selected from the group consisting of:
(a) a backfat thickness measure;
(b) a ribeye depth measure;
(c) a marbling score measure; and
(d) combinations thereof.

9. The method of claim 8, further comprising using the measure in estimating an empty body fat measure.

10. The method of claim 9, further comprising using the estimated empty body fat measure in estimating a future marbling measure.

11. The method of claim 1, wherein a standard shipping date is established based on an average animal weight and an animal type, and wherein the future backfat estimate comprises one selected from the group consisting of:
(a) an estimated backfat measure at a predefined time from a current date;
(b) an estimated backfat measure at the standard shipping date;
(c) an estimated backfat measure at a predefined time after the standard shipping date; and
d) combinations thereof.

12. The method of claim 1, wherein the future weight estimate comprises a weight at a standard shipping date established based on an average animal weight and an animal type.

13. The method of claim 1, wherein the future weight estimate is based at least in part on an estimated daily-gain-to-finish measure for each animal, and wherein the estimated daily-gain-to-finish measure is also directly used in the sorting.

14. The method of claim 13, wherein the sorting is also based on an estimated days-to-critical-weight measure for each animal, the days-to-critical-weight measure being estimated using at least an estimated daily-gain-to-finish measure for each animal and a predefined critical weight for animals.

15. A system for managing animals comprising:
a measurement component that performs physical measurements on animals that arrive in groups and are kept at an animal management location for a yet undetermined time period before being removed therefrom at a shipping date;
an estimation component that generates a future weight estimate and a future backfat estimate for each of the animals, each of the respective estimates being generated using at least one of the physical measurements of the animal and an equation configured to make estimations for a single animal; and
several predetermined sort groups for separate management at the animal management location, the predetermined sort groups being different from the arrival groups and being associated with different predefined shipping dates, wherein the system assigns each of the animals to one of the predetermined sort groups based on the future weight estimate and the future backfat estimate.

16. The system of claim 15, wherein the system provides a feed allocation for administering feed, the feed allocation being determined using a predefined algorithm that takes into account an estimated empty body fat measure generated using an ultrasound measurement.

17. The system of claim 15, wherein the system manages the animals in the several pens separately, including providing a different treatment for at least some of the predetermined sort groups.

18. The system of claim 17, wherein the different treatment comprises a difference in implants that are administered.

19. The system of claim 17, wherein the different treatment comprises a difference in feed allocation.

20. A computer, comprising:
a data input interface configured to receive information relating to animals that are to be kept at an animal management location for a yet undetermined time period before being removed therefrom at a shipping date, the information including at least one physical measurement from the animals; and
a computer program stored in a memory of the computer, the computer program being run on a processor of the computer, the computer program configured to organize the animals into several arrival groups, the computer program configured to generate a future weight estimate and a future backfat estimate for each of the animals, each of the respective estimates being generated using at least one physical measurement of the animal and an equation configured to make estimations for a single animal, and the computer program configured to sort, based on the future weight estimate and the future backfat estimate, each of the animals into one of several predetermined sort groups for separate management at the animal management location, wherein the predetermined sort groups are different from the arrival groups and are associated with different predefined shipping dates.

21. The computer of claim 20, wherein the computer program is configured to provide information relating to managing the predetermined sort groups separately at the animal management location.

22. The computer of claim 21, wherein the separate management comprises providing a different treatment for at least some of the predetermined sort groups.

23. The computer of claim 21, wherein the different treatment comprises a difference in implants that are administered.

24. The computer of claim 21, wherein the separate management comprises administering feed according to a feed allocation that is determined using a predefined algorithm.

25. The computer of claim 24, wherein the predefined algorithm takes into account an estimated empty body fat measure.

26. The computer of claim 25, wherein the estimated empty body fat measure for each animal is generated using an ultrasound measurement.

27. The computer of claim 20, wherein the physical measurement used in generating the future backfat estimate includes at least one measure selected from the group consisting of:
(a) a backfat thickness measure;
(b) a ribeye depth measure;
(c) a marbling score measure; and
(d) combinations thereof.

28. The computer of claim 20, wherein the computer program is configured to use the physical measurement in estimating an empty body fat measure.

29. The computer of claim 28, wherein the computer program is configured to use the estimated empty body fat measure in estimating a future marbling measure.

30. The computer of claim 20, wherein the computer program is configured to establish a standard shipping date based on an average animal weight and an animal type, and wherein the future backfat estimate comprises one selected from the group consisting of:
(a) an estimated backfat measure at a predefined time from a current date;
(b) an estimated backfat measure at the standard shipping date;
(c) an estimated backfat measure at a predefined time after the standard shipping date; and
(d) combinations thereof.

31. The computer of claim 20, wherein the future weight estimate comprises a weight at a standard shipping date established based on an average animal weight and an animal type.

32. The computer of claim 20, wherein the future weight estimate is based at least in part on an estimated daily-gain-to-finish measure for each animal, and wherein the estimated daily-gain-to-finish measure is also directly used in the sorting.

33. The computer of claim 32, wherein the sorting by the computer program is also based on an estimated days-to-critical-weight measure for each animal, the days-to-critical-weight measure being estimated using at least an estimated daily-gain-to-finish measure for each animal and a predefined critical weight for animals.
